(19) United States
(12) Patent Application Publication
(10) Pub. No.: US 2015/0244874 A1
(43) Pub. Date: Aug. 27, 2015

(54) Method and Apparatus for Managing Charging in Communication Networks

(71) Applicant: Telefonaktiebolaget L M Ericsson (publ), Stockholm (SE)

(72) Inventors: Robert Törnkvist, Karlshamn (SE); Hans Andersson, Enskede (SE); Jan Dahl, Alvsjo (SE); Mohammed Issa, Stockholm (SE)

(21) Appl. No.: 14/188,033

(22) Filed: Feb. 24, 2014

(51) Int. Cl. H04M 15/00; H04L 29/06; H04L 12/26

(52) U.S. Cl. CPC H04M 15/57; H04L 43/0817; H04L 65/1006; H04L 65/1016; H04M 15/8228; H04M 15/64

(57) ABSTRACT

According to one aspect of the teachings herein, one or more messages are sent within or from an IP Multimedia Subsystem, IMS, network, to indicate the communication failure of an IMS node supporting a given IMS call session. Advantageously, the one or more messages includes a detection time of the communication failure—e.g., a timestamp—that provides a precision or resolution suitable for adapting a Charging Data Record, CDR, for the affected IMS call session. For example, charges for a portion of the IMS call session are adapted according to the detection time. More broadly, messages indicating the communication failure indication and the corresponding detection time may be exchanged between IMS nodes, e.g., to prompt session termination(s) and/or may be sent to online or offline charging or billing systems, to prevent over-charging.

### TECHNICAL FIELD

The present invention relates to Internet Protocol Multimedia Subsystem, IMS, networks, and particularly relates to charging management in such networks.

### BACKGROUND

For example details regarding charging in a telecommunications network context, see the following Technical Specifications, as promulgated by the Third Generation Partnership Project, referred to as the “3GPP”: TS 32.240 Telecommunication management; Charging management; Charging architecture and principles; TS 32.260 Telecommunication management; Charging management; IP Multimedia Subsystem (IMS) charging; TS 24.229 IP multimedia call control protocol based on Session Initiation Protocol (SIP) and Session Description Protocol (SDP); Stage 3; and TS 32.299 Telecommunication management; Charging management; Diameter charging applications.

The Session Initiation Protocol, SIP, as specified in RFC 3261, is used to create and control user sessions in IP Multimedia Subsystem, IMS, networks. The SIP messages are transported through several IMS functions such as the Proxy-Call Session Control Function, P-CSCF, the Serving-CSCF, S-CSCF, the Telephony Application Server, TAS, etc. Some of these functions also act as Charging Trigger Functions, CTFs, i.e. they generate charging messages using a protocol such as the “Diameter” protocol.

The generation of Diameter charging messages in a CTF is, in most cases, triggered by the receipt of a certain SIP message—a SIP request or response. The same SIP message may trigger charging in all CTFs it passes through. That is, a given IMS call session is supported by multiple IMS nodes in the IMS call chain or signaling path, and one or more of these nodes may include a CTF.

These charging messages are sent to a Charging Data Function, CDF, or an Online Charging Function, OCF, depending on whether offline or online charging mechanisms are in use. The CTF indicates to the CDF/OCF whether to start, update or terminate a charging session based on the SIP message it receives. In case of failure, the CTF has a limited ability to initiate termination of the SIP session towards other IMS nodes and the charging session towards the CDF/OCF.

In any communication network, of course, failures can occur in certain nodes or in the communication links between the nodes. These failures disrupt communications. SIP session timers allow for an effective but limited standard mechanism to discover communication failures between the IMS nodes or functions involved in a SIP session, and to terminate any hanging sessions. These timers are often configurable by the operator and set to values in the magnitude of minutes to reduce traffic and risk for overload.

The charging control system receiving the information from CTFs will likewise have timers supervising the sessions, allowing it to terminate such systems and free any resources in case of timeout. However, these timers are necessarily set to timeout durations that are long enough to ensure that no more data will be received for the session, so that the associated Charging Data Records, CDRs, will not need to be reopened.

Moreover, it is recognized herein that in an IMS call session, the signaling path may be broken as a consequence of a communication failure of one or more nodes supporting the IMS call session. Consequently, the CTF at one or more nodes supporting the affected IMS call session may not receive a SIP BYE from the affected user or from another node in the network. Such CTFs will continue the SIP session as well as the charging session, meaning that the user is at risk of being overcharged. Further, because the OCF keeps reserved funds until its internal timers expire, the affected user may be prevented from using new services during the time that reserved funds are held for the “hung” session.

One solution to the above problem makes use of shorter session timers, for more prompt termination of hung sessions. However, it is recognized herein that shorter session timers would result in undesirably increased signaling overhead in the network. As further recognized herein, it is not practically possible to shorten the session timers sufficiently to fulfill common charging accuracy requirements.

### SUMMARY

According to one aspect of the teachings herein, one or more messages are sent within or from an IP Multimedia Subsystem, IMS, network, to indicate the communication failure of an IMS node supporting a given IMS call session. Advantageously, the one or more messages includes a detection time of the communication failure—e.g., a timestamp—that provides a precision or resolution suitable for adapting a Charging Data Record, CDR, for the affected IMS call session. For example, charges for a portion of the IMS call session are adapted according to the detection time. More broadly, messages indicating the communication failure and the corresponding detection time may be exchanged between IMS nodes, e.g., to prompt session termination(s) and/or may be sent to online or offline charging or billing systems, to prevent over-charging.

In one embodiment, a method at a first IMS node in an IMS network includes detecting a communication failure of a second IMS node supporting the IMS call session, generating one or more messages that indicate the communication failure and a detection time of the communication failure, and sending the one or more messages. Here, the one or more messages are sent to at least one of: a third IMS node supporting the IMS call session and a charging node involved in assessing charges for the IMS call session. The charging node may be a node in an online or offline charging system.

In another embodiment, a first IMS node is configured for operation in an IMS network and includes one or more communication interfaces that are configured to communicate with other IMS nodes to support the IMS call sessions, and to communicate with one or more charging nodes in a charging system. The first IMS node further includes a processing circuit that is operatively associated with the one or more communication interfaces (80) and is configured to detect a communication failure of a second IMS node supporting the IMS call session, generate one or more messages that indicate the communication failure and a detection time of the communication failure, and send the one or more messages, such as to a third IMS node supporting the IMS call session and/or to a charging node involved in assessing charges for the IMS call session.

In a further embodiment, a method in a charging node includes receiving a charging message from a first IMS node in an IMS network, where the first IMS node is involved in an IMS call session and the charging message indicates a communication failure at a second IMS node involved in the IMS call session and indicates a detection time for the communication failure. The method further includes identifying charging information associated with the IMS call session, and adapting the charging information as a function of the detection time.

In yet another embodiment, a charging node includes one or more communication interfaces that are configured to receive a charging message from a first IMS node in an IMS network. Here, the first IMS node is supporting an IMS call session and the charging message indicates a communication failure at a second IMS node that is also supporting the IMS call session and indicates a detection time for the communication failure. Further, the charging node includes a processing circuit that is operatively associated with the one or more communication interfaces (90) and configured to identify charging information associated with the IMS call session, adapt the charging information as a function of the detection time.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of an IP Multimedia Subsystem, IMS, network, shown in context with its associated core IP network, along with one or more access networks and legacy interworking functions.

FIG. 2 is a block diagram of one embodiment of an IMS network, shown in context with various charging nodes, such as in a billings system, an Online Charging System or OCS, and an OFfline Charging System or OFCS.

FIG. 3 is a block diagram of any three IMS nodes that are “neighboring” nodes in a next-hop sense along a signaling path supporting an IMS call session, which nodes are depicted generically and are shown in context with a generic charging node.

FIG. 4 is a block diagram of one embodiment of the generic IMS node introduced in FIG. 3.

FIG. 5 is a logic flow diagram of one embodiment of a method implemented at an IMS node.

FIG. 6 is a block diagram of one embodiment of the generic charging node introduced in FIG. 3.

FIG. 7 is a logic flow diagram of one embodiment of a method implemented at a charging node.

FIGS. 8-11 are call flow diagrams illustrating example call flows.

### DETAILED DESCRIPTION

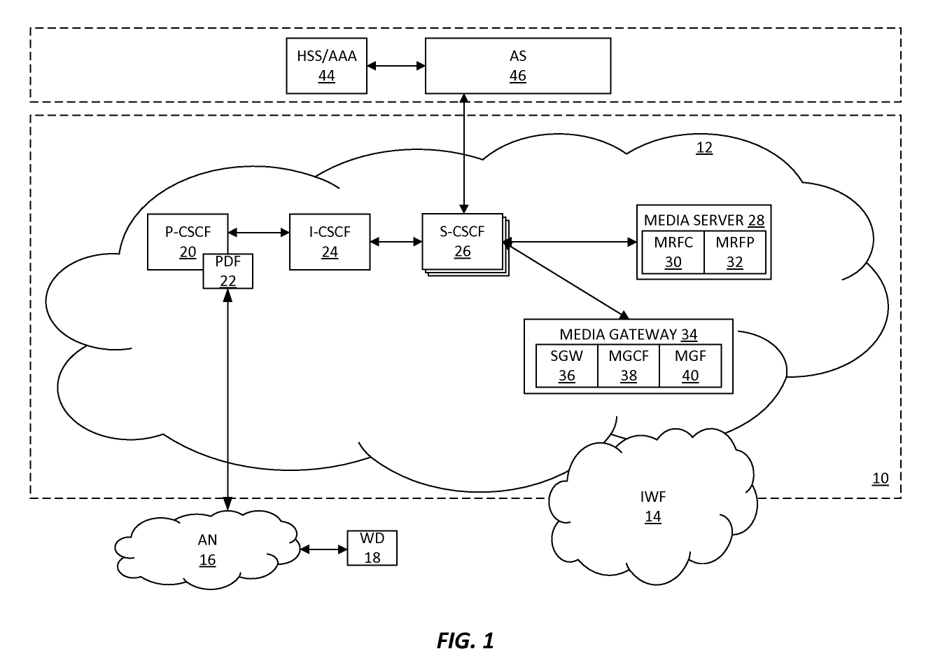

FIG. 1 illustrates one embodiment of an Internet Protocol Multimedia Subsystem, IMS, network 10, where one or more IMS network nodes and one or more charging system nodes are configured according to the teachings herein. That is, a first IMS network node is configured to detect a communication failure at another IMS network node that affects one or more IMS call sessions supported by the first IMS node, and to generate and send one or more messages indicating the communication failure and indicating a detection time for the communication failure. Correspondingly, one or more charging system nodes are configured to adapt charging for at least a portion of the affected IMS call session(s), as a function of the detection time and/or to indicate the communication failure and detection time in charging information generated for downstream billing nodes.

To better understand these advantageous configurations and operations, the example IMS network 10 includes or is associated with a number of elements or entities. Among them is an interworking function, IWF, for coupling the IMS network 10 to legacy networks, which are not shown in FIG. 1. Further, one sees an access network 16 that communicatively couples a wireless device 18 to the IMS network 10. In a non-limiting example, the access network or AN 16 comprises a Third Generation Partnership Project, 3GPP, AN, such as a GSM, WCDMA or LTE network. Further, in the 3GPP context, the wireless device 18 would be referred to as a User Equipment or UE. However, the term “wireless device” as used herein denotes essentially any type of wireless communication apparatus, such as a smart phone, feature phone, tablet, laptop computer, network adaptor or modem, Machine-Type-Communication device, etc. Moreover, the teachings herein are not limited to wireless access or any other particular type of access network by which use of the IMS network 10 is gained.

The IMS network 10 uses an IP core network 12 to communicatively interconnect a number of IMS nodes or functions. Among the various nodes or functions illustrated in the simplified IMS network example of FIG. 1, one sees a Proxy Call Session Control, P-CSCF, 20, which is associated with or includes a Policy Decision Function, PDF, 22. One further sees an Interrogating CSCF, I-CSCF, 24, one or more Serving CSCFs, S-CSCFs, 26, along with a Media Server 34, including a Media Resource Function Controller, MRFC, 30, and a Media Resource Function Processor, MRFP, 32. Still further, one sees a Media Gateway 34, including a Serving Gateway, SGW, 36, a Media Gateway Controller Function, MGCF, 38, and a Media Gateway Function, MGF, 40. Finally, while not part of the IMS core, the IMS network 10 couples to any number of other entities, such as a Home Subscriber Server, HSS, and/or Access, Authentication, and Accounting Server, AAA, 44, and one or more Application Servers, AS, 46.

The P-CSCF 20 provides a first point of contact for users with the IMS network 10 and it is responsible for security of the messages between the IMS network 10 and users, e.g., the wireless device 18. The P-CSCF 20 also allocates resources for the media flows. While not detailed in the diagram, the I-CSCF 24 operates as a point of contact with respect to peered networks, and it is responsible for querying the HSS 44, to determine the S-CSCF 26 for a given user. Further, the S-CSCF 26 processes registrations to record the location of each user of the IMS network 10, and is responsible for user authentication, and call processing. Call processing in this sense includes the routing of calls to applications provided by the AS 46. Stored policies in the HSS 44 control operation of the S-CSCF 26.

Conventional operational aspects of the above nodes are readily publicized and are not further detailed herein. Likewise, details for the conventional aspects of operation for the Media Server 28 and the Media Gateway 34 are not detailed herein, as such conventional details are not germane to understanding the teachings herein. Instead, the remainder of the discussion focuses on the non-conventional aspects of one or more of the IMS nodes in the IMS network 10. These teachings are not limited to any one or more of the particular nodes illustrated and it should be understood by those of ordinary skill in the art that the teachings taught herein can be applied to essentially any IMS node that functions as part of the signaling path or call chain used to support IMS call sessions established in or through the IMS network 10. Any one or more of the P-CSCF 20, I-CSCF 24, S-CSCF 26, Media Server 28, and Media Gateway 34 may function as such an IMS node.

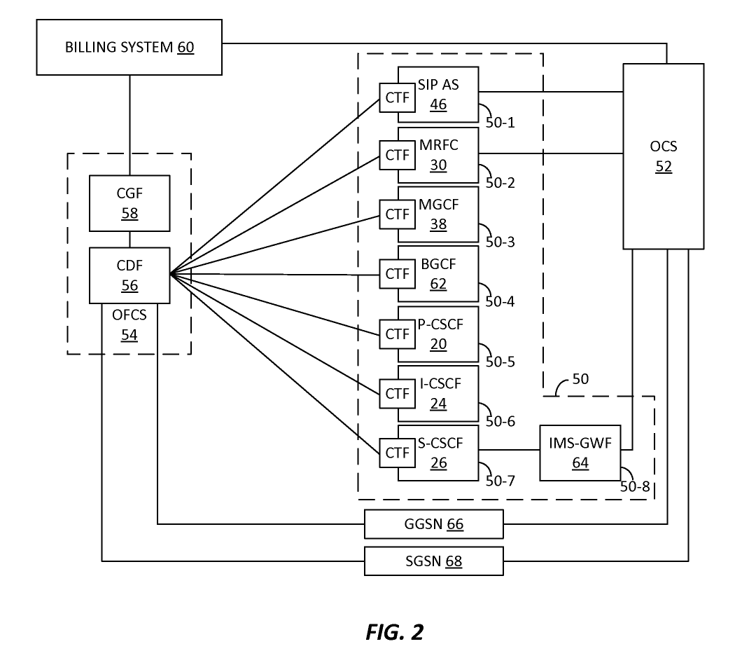

Consider FIG. 2, for example, which illustrates a larger set of example IMS nodes, any one or more of which can be configured according to the teachings herein. One sees the aforementioned P-CSCF 20, I-CSCF 24, S-CSCF 26, MRFC 30, MGCF 38, and (SIP) AS 46. Additionally illustrated nodes include a Border Gateway Control Function, BGCF, 62 and an IMS Gateway Function, IMS-GWF, 64. Still further, one sees additional nodes or entities associated with the IMS network 10, particularly those in or supporting charging operations.

For example, FIG. 2 illustrates a Gateway GPRS Support Node, GGSN, 66, and a Serving GPRS Support Node, SGSN, 66. These nodes are responsible for the internetworking between a GPRS network—not shown—and external packet-switched networks. One further sees an Online Charging System, OCS, 52, and an Offline Charging System, OFCS, 54, which includes a Charging Data Function, CDF, 56, and a Charging Gateway Function, CGF, 58. The OCS 52 and OFCS 54 are each shown as interconnecting with a downstream billing system 60.

One or more of the IMS nodes of interest herein may include a CTF, as previously described. However, it should be noted that at least some of the teachings herein apply directly to IMS nodes without a CTF—e.g., the termination and information or notification messages contemplated herein may be generated and sent from an IMS node regardless of whether or not the node includes a CTF. Further, for convenience, the example set of IMS nodes shown in FIG. 2 are simply and generically referred to as IMS nodes 50. If suffixes are not needed for clarity, then an IMS node configured according to one or more embodiments taught herein is referred to simply as an “IMS node 50.” Suffixes are used when needed for clarity, e.g., for distinguishing between individual IMS nodes 50, such as “IMS node 50-1”, “IMS node 50-2”, and so on.

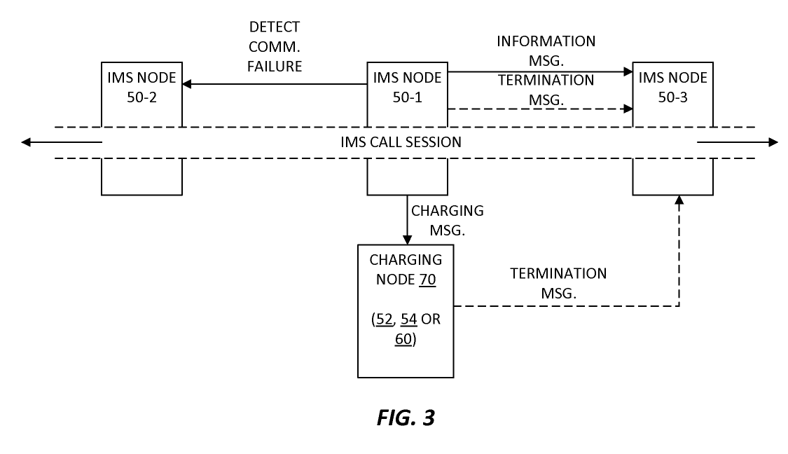

This suffix-based annotation is used in FIG. 3, to distinguish between first, second and third IMS nodes 50, shown as a first IMS node 50-1, a second IMS node 50-2, and a third IMS node 50-3. These IMS nodes 50 may comprise any one or more types of IMS nodes or functions, but for purposes of the illustration they are to be understood as all supporting a given IMS call session—i.e., the three IMS nodes 50 are associated inasmuch as they are all part of the signaling path or call chain within the IMS network 10 used to support the given IMS call session at issue. Of course, these IMS nodes 50 may support a plurality of IMS call sessions simultaneously and it shall be understood that the teachings herein can be applied batch-wise or session-wise, to any number of affected IMS call sessions.

According to FIG. 3, the first IMS node 50-1 detects a communication failure of a second IMS node 50-2. In response to that detection—which may be based on its own observations of signaling failures with respect to the second IMS node 50-2, or which may be based on receiving a failure indication from another node—the first IMS node 50-1 generates one or more messages to indicate the communication failure and to indicate the detection time of the communication failure. For example, the first IMS node 50-1 generates and sends an information message to a third IMS node 50-3, which is also supporting the affected IMS call session. Additionally, or alternatively, the first IMS node 50-1 generates and sends a termination message to the third IMS node 50-3, to initiate termination of the affected IMS call session. Of course, one or both such messages can be sent to any number of affected nodes in the IMS network 10.

Additionally or alternatively, the first IMS node 50-1 generates and sends a charging message to a charging node 70. Advantageously, the charging message indicates the communication failure and indicates the detection time for the communication failure, such that the charging node 70 can adapt charges assessed for the affected IMS call session as a function of the detected time of the communication failure and/or indicate the communication failure in charging information generated for a downstream billing system node that is configured to account for the communication failure.

Several points are notable here. The “charging node 70” in one example should be understood as generically representing any one or more of the OCS 52, the OFCS 54, and the billing system 60—or any node, function or entity within them. Further, it is contemplated that the first IMS node 50-1 includes a CTF or the like, at least for embodiments involving the generation and sending of charging messages. However, even if the IMS node 50-1 does not include a CTF, it may send an information and/or termination message to another IMS node 50 that does include a CTF or the like. In turn, that other IMS node 50 is configured to take the communication failure and detection time indications from the received information and/or termination message(s), and generate the appropriate charging message(s). As such, the teachings herein provide for the propagation of communication failure detections and corresponding detection times to one or more charging nodes 70, for use in determining the charges assessed against users for IMS call sessions affected by the detected communication failure(s).

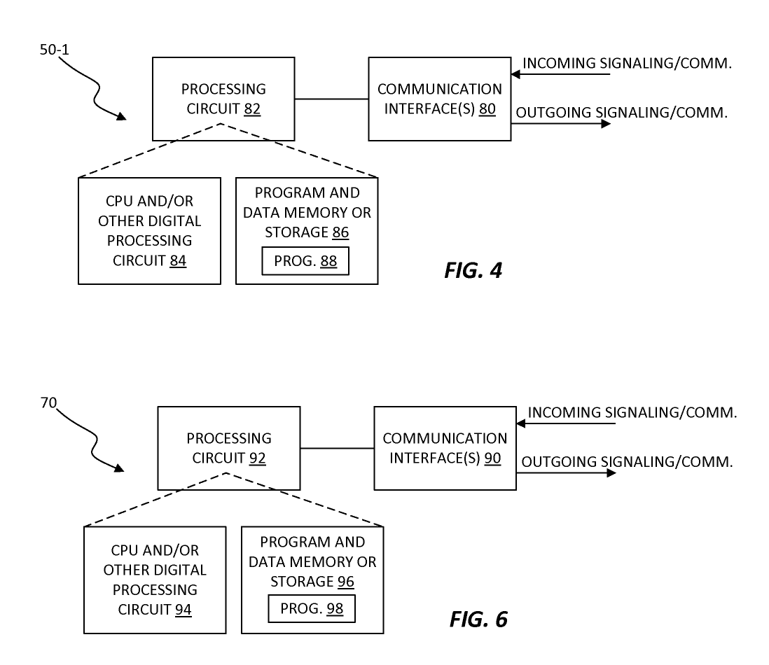

FIG. 4 illustrates an example of an IMS node 50, according to one or more embodiments contemplated herein. The illustrated node 50 is referred to as a first IMS node 50-1 merely for the sake of convenient reference and it includes one or more communication interfaces 80 configured to communicate with other IMS nodes 50 to support the IMS call sessions. Further, in at least some embodiments, the one or more communication interfaces 80 are configured to communicate with one or more charging nodes 70 in a charging system—e.g., with any one or more of an OCS 52, an OFCS 54, and a billing system 60. Each of the one or more communication interfaces 80 comprises, for example, physical-layer interface circuitry and associated protocol processing circuitry.

The first IMS node 50-1 further comprises a processing circuit 82 that is operatively associated with the one or more communication interfaces 80. The processing circuit 82 comprises, for example, a microcontroller-based, DSP-based, FGPA-based, or ASIC-based circuit, e.g., having a CPU, or other digital processing circuitry 84. The digital processing circuitry 84 includes or is associated with program and data memory or storage 86. In one embodiment, the program and data memory or storage 86 provides non-volatile, non-transitory storage of a computer program 88, which computer program 88 comprises program instructions the execution of which configures the processing circuit 82 according to the teachings herein.

Whether configured via dedicated circuitry or programmed circuitry, the processing circuit 82 is configured to detect a communication failure of a second IMS node 50-2 supporting the IMS call session—the second IMS node 50-2 is not shown. The processing circuit 82 is further configured to generate one or more messages that indicate the communication failure and a detection time of the communication failure and send the one or more messages to at least one of: a third IMS node 50-3 supporting the IMS call session, and a charging node 70 involved in assessing charges for the IMS call session.

In an example embodiment, the processing circuit 82 is configured to detect the communication failure based on determining that the second IMS node 50-2 has not timely responded to one or more messages sent from the first IMS node 50-1 to the second IMS node 50-2. In another example embodiment, the processing circuit 82 is configured to detect the communication failure based on receiving a message from the third IMS node 50-3 or another functioning IMS node 50 in the IMS network 10, indicating the communication failure of the second IMS node 50-2. Such message may indicate the detection time of the communication failure. Of course, it is contemplated that an IMS node 50 be configured with both detection capabilities—i.e., detecting the communication failure of another IMS node 50 based on signaling problems to or from that other IMS node 50, and detecting the communication failure of another IMS node 50 based on receiving a message from yet another IMS node 50, where that message indicates the communication failure and the detection time of the communication failure. It will be understood that the message may include additional information, such as an identifier of the failed IMS node 50, call session identifiers or other such information, etc.

In the same or another example embodiment, the processing circuit 82 is configured to generate the one or more messages by generating a charging message for a charging node 70, for use by the charging node 70 in determining charges assessed for the IMS call session. For example, the processing circuit 82 is configured to generate the charging message by generating at least one of an ACcounting Request, ACR, message and a Credit Control Request, CCR, message. The processing circuit 82 sends the one or more messages by at least one of: sending the ACR message to a Charging Data Function, CDF, node 56 as the charging node 70; and sending the CCR message to an Online Charging System, OCS, node 52 as the charging node 70.

In the same or another example embodiment, the processing circuit 82 is configured to generate the one or more messages to at least include a termination message for the third IMS node 50-3, to initiate termination of the IMS call session. Additionally, or alternatively, the processing circuit 82 is configured to generate the one or more messages to at least include an information message for the third IMS node 50-3, to inform the third IMS node 50-3 of the communication failure of the second IMS node 50-2. The information message may prompt the third IMS node 50-3 to initiate termination of the affected call session and/or to generate and send a charging message, but unlike the termination message the information message is not an explicit directive to terminate the affected IMS call session. Of course, the third IMS node 50-3 may be configured to forward the information message to yet another IMS node 50.

Thus, in response to detecting the communication failure of the second IMS node 50-2, the processing circuit 82 of the first IMS node 50-1 is configured to generate at least one of the following: a charging message for a charging node 70, an information message for one or more other IMS nodes 50, and a termination message for one or more other IMS nodes 50. Each type of message at least includes indications of the communication failure and the detection time for the communication failure. Thus, the information message allows another IMS node 50 that receives the information message to do at least one of the following: provide the information to another IMS node 50, provide the information to a charging node 70, and initiate termination of the IMS call session. Of course, the call termination messaging also carries indications of the communication failure and the detection time of the communication failure, so that the cause of the termination is identifiable and so that the information can be propagated to one or more other IMS nodes 50 and/or to one or more charging nodes 70.

In the same or another example embodiment, the processing circuit 82 is configured to identify whether there are any additional IMS call sessions supported by the first and second IMS nodes 50-1, 50-2, and to repeat the operations of generating the one or more messages and sending the one or more messages, for each identified additional IMS call session. Equivalently, the first IMS node 50-1 may send a message that indicates the communication failure and detection time for more than one IMS call session—e.g., for all IMS call sessions that are being supported by the first and second IMS nodes 50-1 and 50-2.

In the same or another example embodiment, the processing circuit 82 is configured to at least temporarily store session information at the first IMS node 50-1 for each IMS call session supported by the first IMS node 50-1. The session information identifies at least those neighboring IMS nodes 50 supporting each IMS call session. For each IMS call session identified in the session information as being supported by a given neighboring IMS node 50 that is detected as experiencing a communication failure while supporting the IMS call session, the processing circuit 82 is configured to send one or more messages to one or more other nodes, indicating the communication failure and a detection time of the communication failure.

In the same or another embodiment, for one or more session-related or charging-related messages that are triggered by a session event involving any given IMS session supported by the first and second IMS nodes 50-1 and 50-2, the processing circuit 82 of the first IMS node 50-1 is configured to include in the one ore more session-related or charging-related messages an indication of the communication failure and the detection time as interim information for the given IMS session. This approach provides interim information to other node(s), e.g., one or more other IMS nodes 50 that are also supporting the affected session and/or one or more charging nodes 70 associated with determining charges for the affected session. That is, the first IMS node 50-1 in some embodiments advantageously includes indications of the detected communication failure and detection time in one or more session-related and/or charging messages that are naturally sent in response to given session-related triggering events.

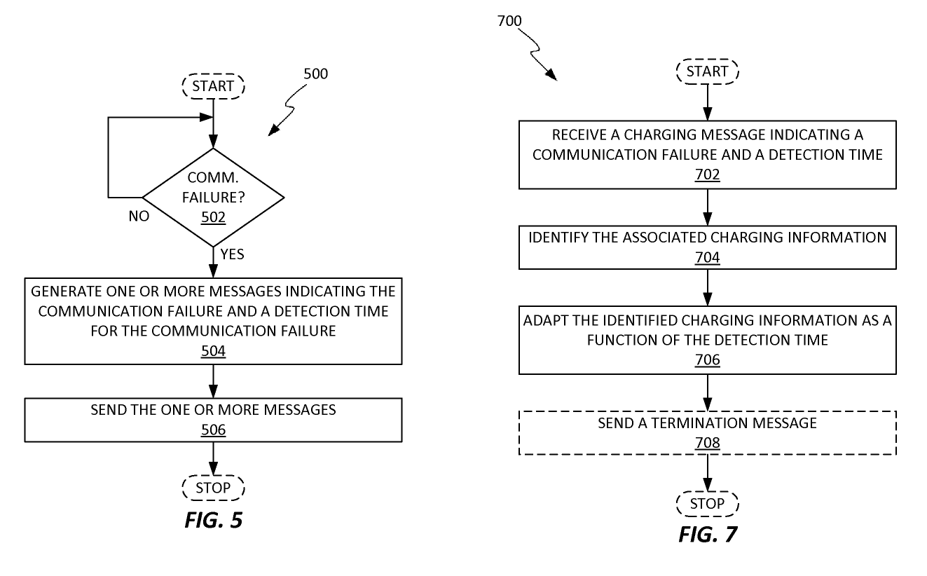

FIG. 5 illustrates a method 500 implemented by a first IMS node 50-1. Note that this functionality may be realized via the circuitry illustrated by way of example in FIG. 4, or may use another circuit arrangement. Further, it shall be understood that one or more of the processing operations or steps illustrated in FIG. 5 may be performed in an order other than that suggested by the example illustration. Still further, it shall be understood that the method 500 may be performed repeated or in parallel for any number of IMS call sessions and that the processing represented by the method 500 may be performed by the first IMS node 50-1 as part of other or overall processing operations.

The method 500 includes detecting (Block 502) a communication failure of a second IMS node 50-2 supporting the IMS call session. The second IMS node 50-2 is a neighboring node, for example. Here, “neighboring” means adjacent to the first IMS node 50-1 with respect to the call chain or signaling path of an IMS call session. The method 500 further includes generating (Block 504) one or more messages that indicate the communication failure and a detection time of the communication failure, and sending (Block 506) the one or more messages. As noted before, the first IMS node 50-1 may send a message to a third IMS node 50-3 supporting the IMS call session and/or to a charging node 70 involved in assessing charges for the IMS call session.

Thus, in one or more embodiments disclosed herein, a first IMS node 50-1 is configured to support an IMS session within an IMS network 10, and comprises a communication detection failure unit or means for detecting a communication failure of a second IMS node 50-2 supporting the IMS call session, and further comprises a message generation unit or means for generating one or more messages that indicate the communication failure and a detection time of the communication failure. Further, the first IMS node 50-1 a sending unit or means for sending the one or more messages to at least one of: a third IMS node 50-3 supporting the IMS call session; and a charging node 70 involved in assessing charges for the IMS call session.

FIG. 6 illustrates an example of a charging node 70, according to one or more embodiments contemplated herein. The illustrated charging node 70 may be implemented, for example, in the OCS 52 or the OFCS 54 and it includes one or more communication interfaces 90 configured to communicate with the IMS network 10 and/or with other charging nodes. Particularly, the one or more communication interfaces 90 are configured to receive a charging message from a first IMS node 50-1 in the IMS network 10. The charging message relates to an IMS call session supported by the first IMS node 50-1 and it indicates a communication failure at a second IMS node 50-2 supporting the IMS call session. The charging message further indicates a detection time for the communication failure.

Each of the one or more communication interfaces 90 comprises, for example, physical-layer interface circuitry and associated protocol processing circuitry and the charging node 70 further comprises a processing circuit 92 that is operatively associated with the one or more communication interfaces 90. The processing circuit 92 comprises, for example, a microcontroller-based, DSP-based, FGPA-based, or ASIC-based circuit, e.g., having a CPU, or other digital processing circuitry 94. The digital processing circuitry 94 includes or is associated with program and data memory or storage 96. In one embodiment, the program and data memory or storage 96 provides non-volatile, non-transitory storage of a computer program 98, which computer program 98 comprises program instructions, the execution of which configures the processing circuit 92 according to the teachings herein.

Whether configured via dedicated circuitry or programmed circuitry, the processing circuit 92 is configured to identify charging information associated with the IMS call session associated with the received charging message. For example, the received charging message includes a call session identifier or other information enabling the processing circuit 92 to determine the IMS call session at issue in the received charging message. The processing circuit 92 is further configured to adapt the charging information—for the affected IMS call session—as a function of the detection time indicated for the communication failure.

In some embodiments, or in at least some cases, the processing circuit 92 is configured to initiate termination of the IMS call session responsive to receiving the charging message. In the same or other embodiments, the processing circuit 92 is configured to adapt the charging information as a function of the detection time by performing at least one of: adapting charges for at least a portion of the IMS call session; and indicating the communication failure in a charging record generated for the IMS call session, for use by a downstream billing system node in adapting charges assessed for the IMS call session. For example, the charging node 70 is a CDF 56 in an OFCS 54, and the processing circuit 92 generates a CDR for the affected IMS call session that includes information indicating the communication failure and the detection time. In turn, a downstream node in a billing system 60 uses that information in the CDR to adapt billing for the IMS call session, for the involved subscriber(s). Alternatively, the CDR is generated to already account for the communication failure—e.g., by adjusting the call session time, etc., as a function of the communication failure and its detection time.

In particular, charging node 70 in such embodiments comprises a CDF node 56 and the charging messages comprises an ACcounting Request, ACR, message. In other embodiments, the charging node 70 comprises a node within an OCS 52, and the charging message comprises a Credit Control Request, CCR. In any case, adapting the charges for an affected IMS call session includes, for example, discounting or zeroing charges, e.g., for at least that portion of the IMS call session that extends beyond the detection time of the communication failure. In some embodiments, or in some cases, e.g., depending on what portion of the total IMS call session time is affected by the communication failure, the charging node 70 may zero charges for the entire session, or may account for the communication failure by calculating credits to be applied to the involved subscriber account(s).

In at least one embodiment, the processing circuit 92 is configured to, in response to the charging message, identify any additional IMS call sessions being supported by the first and second IMS nodes 50-1, 50-2. Correspondingly, the processing circuit 92 is configured to perform at least one of: initiate termination of each identified additional IMS call session, and adapt charging information associated with each additional IMS call session, as a function of the detection time.

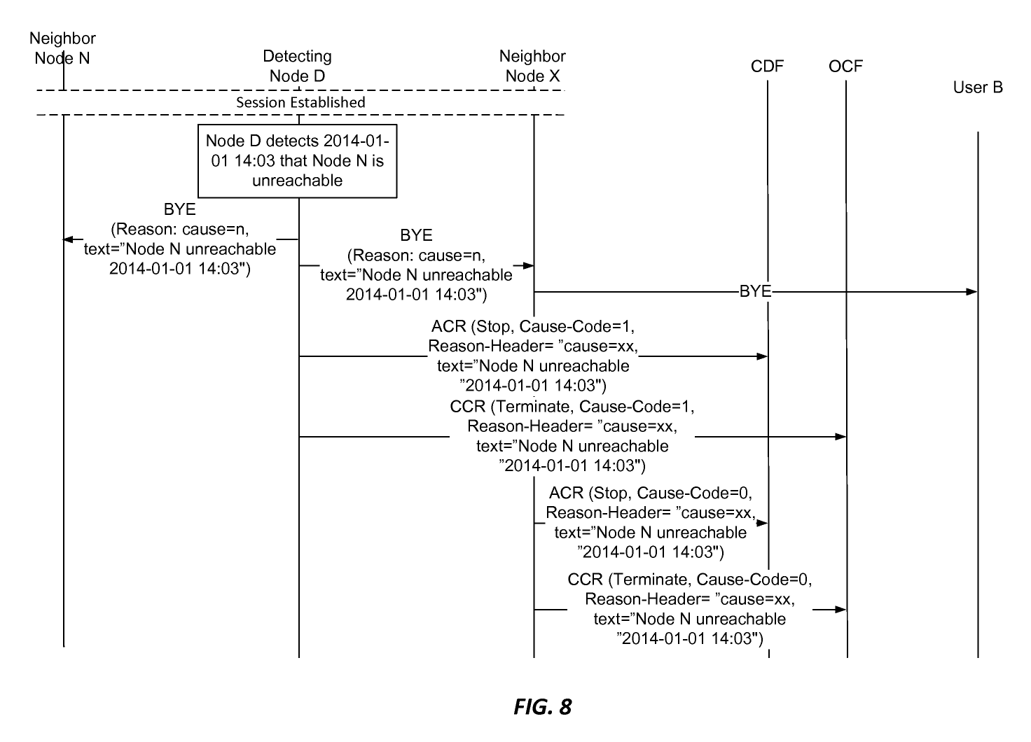

FIG. 7 illustrates a method 700 implemented by a charging node 70. Note that this functionality may be realized via the circuitry illustrated by way of example in FIG. 6, or may use another circuit arrangement. Further, it shall be understood that one or more of the processing operations or steps illustrated in FIG. 7 may be performed in an order other than that suggested by the example illustration. Still further, it shall be understood that the method 700 may be performed repeated or in parallel for any number of IMS call sessions and that the processing represented by the method 700 may be performed by the first charging node 70 as part of other or overall processing operations.

The method 700 includes receiving (Block 702) a charging message from a first IMS node 50-1 in an IMS network 10. The first IMS node 50-1 is involved in an IMS call session and the charging message indicates a communication failure at a second IMS node 50-2 that is also involved in the IMS call session. The charging message further indicates a detection time for the communication failure. Correspondingly, the method 700 includes identifying (Block 704) charging information associated with the IMS call session—e.g., a pending CDR or other data record to be used for charging the affected IMS call session—and adapting (Block 706) the charging information as a function of the detection time. The method 700 also may include initiating (Block 708) termination of the IMS call session, responsive to receiving the charging message.

In some embodiments, adapting (Block 706) the charging information as a function of the detection time comprises at least one of: adapting charges for at least a portion of the IMS call session; and indicating the communication failure in a charging record generated for the IMS call session, for use by a downstream billing system node in adapting charges assessed for the IMS call session. In the same or other embodiments, receiving (Block 702) the charging message comprises one of: receiving an ACR message at CDF node 56 as the subject charging node 70; and receiving a CCR message at an OCS 52, as the subject charging node 70.

Thus, in one or more embodiments, a charging node 70 is configured for implementing charging, based on including a receiving unit or means for receiving a charging message from a given IMS node 50 in an IMS network 10, e.g., a first IMS node 50-1 in the IMS network 10. Here, the first IMS node 50-1 is involved in an IMS call session and the charging message indicates a communication failure at a second IMS node 50-2 involved in the IMS call session and a detection time for the communication failure. The charging node 70 further includes an identifying unit or means for identifying charging information associated with the IMS call session, and an adapting unit or means for adapting the charging information as a function of the detection time.

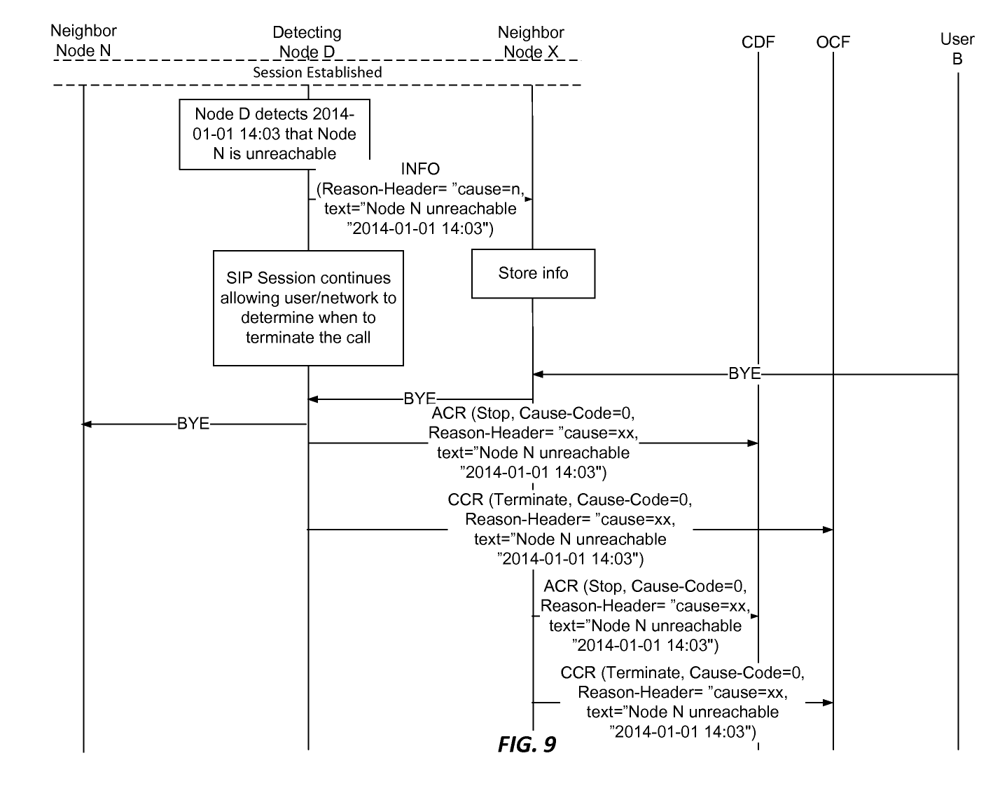

FIG. 8 illustrates an example call flow for an IMS call session in which a supporting IMS node 50 experiences a communication failure that is detected by another IMS node 50 supporting the IMS call session. Thus, the “Detecting Node D”, “Neighbor Node N”, and “Neighbor Node X” should be understood as three different IMS nodes 50 supporting the same IMS call session. One also sees a “User B” denoting a wireless device 18 or other subscriber equipment involved in the IMS call session at issue, along with a CDF and an OCF, which corresponds to, for example, the CDF 56 of the OFCS node 54 and OCS 52 shown in FIG. 2.

After the Detecting Node D, “node D”, has detected for an IMS call session that Neighbor Node N, “node N”, has failed, node D terminates the failing session by sending a SIP BYE with, e.g., a Reason header indicating the cause for the termination, the identity of failing node N, and a timestamp. Node D will also terminate possible existing charging sessions it has for the SIP session in question, including reporting the reason for termination, the identity of node N and the time of the failure detection. Such processing and signaling is captured in the example call flow.

FIG. 9 illustrates a variant of the call flow introduced in FIG. 8. Here, the node D does not terminate the SIP session immediately and instead stores the information about the failing neighbor node N, including a timestamp, and adds this information in the next charging message. Termination of the service is then triggered by user behavior or through another mechanism in the network.

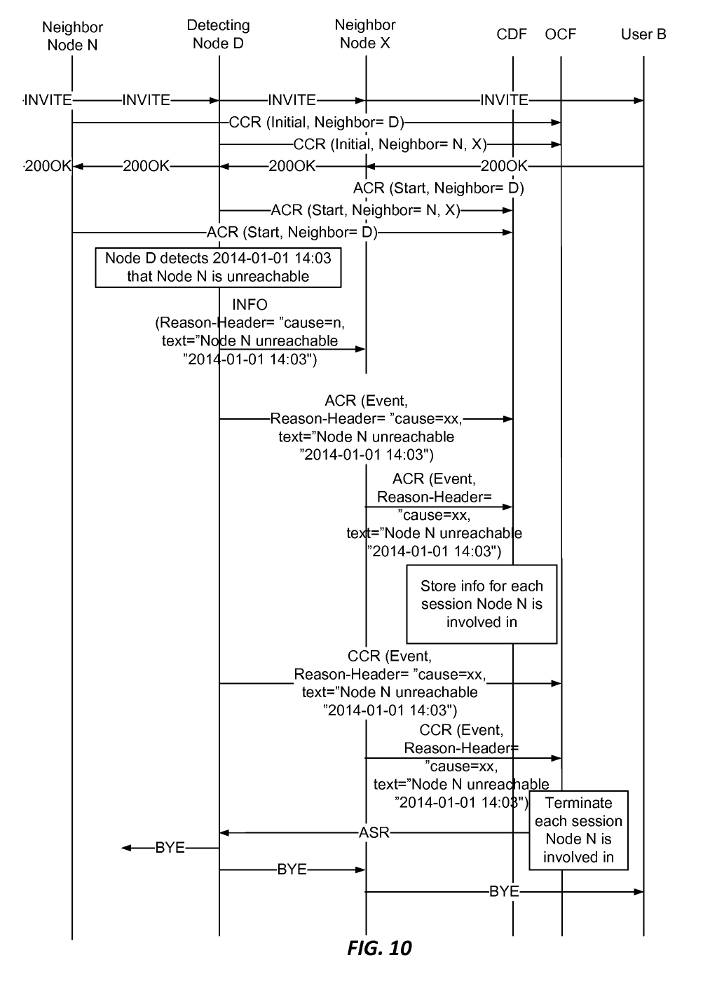

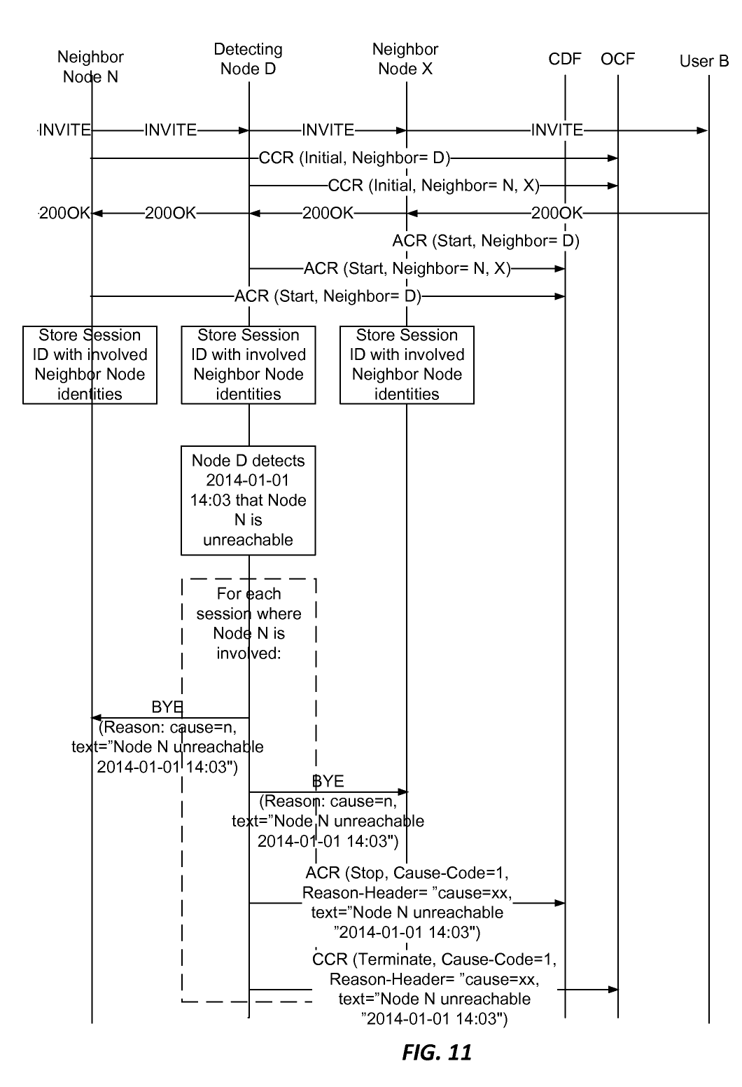

FIG. 10 illustrates yet another variant. Here, the node D sends a session-unrelated message to inform the CDF/OCF about the failure of the node N. This information message includes a timestamp for the detected communication failure of the node N. The OCF can then choose to terminate the session or leave the termination decision up to the users/nodes. Each node includes in the charging data the identity of each neighbor node in the IMS call session and, in response to the detected communication failure of a given IMS node 50, the CDF/OCF may directly handle all IMS call sessions being supported by the failed IMS node 50, without waiting to receive information for each affected call session.

Independent of the particular failure detection mechanism used to detect the communication failure of the node N, the node D can, upon detecting the node N as failed, find all ongoing IMS call sessions being supported by it which are also supported by the node N. As such, the node D can handle each such identified IMS call session according to the teachings herein.

Further, once the CDF/OCF has been informed about a failed IMS node 50, it can take appropriate actions. Such actions include any one or more of the following example actions: add the failure information to all ongoing sessions involving the failed IMS node 50; terminate all ongoing sessions involving the failed IMS node 50; set all involved sessions as being free of charge; or set a portion of each affected session as being free of charge, such as from a last debiting of the account or from the detection time of the communication failure.

When a CTF in a first IMS node 50-1 detects that a neighboring second IMS node 50-2 has failed, the CTF in the first IMS node 50-1 shall report in the generated charging information the identity of the failing neighbor node and the time the failure was detected. Here, the second IMS node 50-2 is considered a neighboring node for purposes of the involved IMS call session(s) because the first and second IMS nodes 50-1 and 50-2 have one or more direct SIP links between them, for supporting the IMS call session(s).

The CTF identifying the node failure shall also forward the same information in its SIP signaling with one or more other IMS nodes 50, thereby informing other IMS nodes 50 involved in the session the reason for the termination. These operations make it possible for other CTFs in one or more other involved IMS nodes 50 to include the termination reason in their charging messages.

Advantageously, these and other operations taught herein enable a charging control systems, e.g., a CDF and/or OCF, to be informed if there is a point of failure in the IMS network 10, and to optionally terminate all charging sessions related to that point of failure. This approach ensures that the involved subscriber(s) are not over-charged as a result of the communication failure and that the network operator keeps interconnection costs as low as possible.

Such operations also provide for automatically updating subscriber accounts and bills, to ensure they are as accurate as possible. The timestamp set at the communication failure detection time, together with knowledge of the detection mechanism used to detect the communication failure, enables direct calculation of the node failure time, without need for correlating with charging data from other nodes and/or alarms/logs from Operations & Maintenance nodes, etc. Further, it is contemplated to use the same or similar mechanism to report the status of a neighboring IMS node 50, when there is a risk that it will negatively affect ongoing service, e.g. in cases of over-load.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method in a first IP Multimedia Subsystem, IMS, node supporting an IMS call session, the method comprising:
detecting a communication failure of a second IMS node supporting the IMS call session;
generating one or more messages that indicate the communication failure and a detection time of the communication failure; and
sending the one or more messages to at least one of:
a third IMS node supporting the IMS call session; and
a charging node involved in assessing charges for the IMS call session.

2. The method of claim 1, wherein detecting the communication failure comprises determining that the second IMS node has not timely responded to one or more messages sent from the first IMS node to the second IMS node.

3. The method of claim 1, wherein detecting the communication failure comprises receiving a message from the third IMS node or another functioning IMS node in an IMS network, indicating the communication failure of the second IMS node.

4. The method of claim 1, wherein generating the one or more messages comprises generating a charging message for the charging node, for use by the charging node in determining charges assessed for the IMS call session.

5. The method of claim 4, wherein generating the charging message comprises generating at least one of an ACcounting Request, ACR, message and a Credit Control Request, CCR, message, and wherein sending the one or more messages comprises at least one of: sending the ACR message to a Charging Data Function, CDF, node as said charging node; and sending the CCR message to an Online Charging System, OCS, node as said charging node.

6. The method of claim 1, wherein generating the one or more messages includes generating a termination message for the third IMS node, to initiate termination of the IMS call session.

7. The method of claim 1, wherein generating the one or more messages includes generating an information message for the third IMS node, to inform the third IMS node of the communication failure of the second IMS node.

8. The method of claim 1, further comprising identifying whether there are any additional IMS call sessions supported by the first and second IMS nodes, and wherein the method includes repeating said steps of generating and sending for each identified additional IMS call session

9. The method of claim 1, further comprising at least temporarily storing session information at the first IMS node for each IMS call session supported by the first IMS node, wherein the session information identifies at least those neighboring IMS nodes supporting the IMS call session, and, for each IMS call session identified in the session information as being supported by a given neighboring IMS node that was detected as experiencing a communication failure while supporting the IMS call session, sending one or more messages to one or more other nodes, indicating the communication failure and a detection time of the communication failure.

10. The method of claim 1, further comprising, for one or more session-related or charging-related messages that are triggered by a session event involving any given IMS session supported by the first and second IMS nodes, including in the one or more session-related or charging-related messages an indication of the communication failure and the detection time as interim information for the given IMS session.

11. An IP Multimedia Subsystem, IMS, node referred to as a first IMS node and comprising:
one or more communication interfaces configured to communicate with other IMS nodes to support the IMS call sessions, and to communicate with one or more charging nodes in a charging system; and
a processing circuit that is operatively associated with the one or more communication interfaces and is configured to:
detect a communication failure of a second IMS node supporting the IMS call session;
generate one or more messages that indicate the communication failure and a detection time of the communication failure; and
send the one or more messages to at least one of:
a third IMS node supporting the IMS call session; and
a charging node involved in assessing charges for the IMS call session.

12. The first IMS node of claim 11, wherein the processing circuit is configured to detect the communication failure based on determining that the second IMS node has not timely responded to one or more messages sent from the first IMS node to the second IMS node.

13. The first IMS node of claim 11, wherein the processing circuit is configured to detect the communication failure based on receiving a message from the third IMS node or another functioning IMS node in an IMS network, indicating the communication failure of the second IMS node.

14. The first IMS node of claim 11, wherein the processing circuit is configured to generate the one or more messages by generating a charging message for the charging node, for use by the charging node in determining charges assessed for the IMS call session.

15. The first IMS node of claim 14, wherein the processing circuit is configured to generate the charging message by generating at least one of an ACcounting Request, ACR, message and a Credit Control Request, CCR, message, and wherein the processing circuit is configured to send the one or more messages by at least one of: sending the ACR message to a Charging Data Function, CDF, node as said charging node; and sending the CCR message to an Online Charging System, OCS, node as said charging node.

16. The first IMS node of claim 11, wherein the processing circuit is configured to generate the one or more messages as at least including a termination message for the third IMS node, to initiate termination of the IMS call session.

17. The first IMS node of claim 11, wherein the processing circuit is configured to generate the one or more messages as at least including an information message for the third IMS node, to inform the third IMS node of the communication failure of the second IMS node.

18. The first IMS node of claim 11, wherein the processing circuit is configured to identify whether there are any additional IMS call sessions supported by the first and second IMS nodes, and repeat the operations of generating the one or more messages and sending the one or more messages, for each identified additional IMS call session

19. The first IMS node of claim 11, wherein the processing circuit is configured to at least temporarily store session information at the first IMS node for each IMS call session supported by the first IMS node, wherein the session information identifies at least those neighboring IMS nodes supporting the IMS call session, and, for each IMS call session identified in the session information as being supported by a given neighboring IMS node that was detected as experiencing a communication failure while supporting the IMS call session, send one or more messages to one or more other nodes, indicating the communication failure and a detection time of the communication failure.

20. The first IMS node of claim 11, wherein, for one or more session-related or charging-related messages that are triggered by a session event involving any given IMS session supported by the first and second IMS nodes, the processing circuit is configured to include in the one ore more session-related or charging-related messages an indication of the communication failure and the detection time as interim information for the given IMS session.

21. A method in a charging node comprising:
receiving a charging message from a first IP Multimedia Subsystem, IMS, node in an IMS network, where the first IMS node is involved in an IMS call session and the charging message indicates a communication failure at a second IMS node involved in the IMS call session and a detection time for the communication failure;
identifying charging information associated with the IMS call session; and
adapting the charging information as a function of the detection time.

22. The method of claim 21, further comprising initiating termination of the IMS call session, responsive to receiving the charging message.

23. The method of claim 21, wherein adapting the charging information as a function of the detection time comprises at least one of: adapting charges for at least a portion of the IMS call session; and indicating the communication failure in a charging record generated for the IMS call session, for use by a downstream billing system in adapting charges assessed for the IMS call session.

24. The method of claim 21, wherein receiving the charging message comprises one of: receiving an ACcounting Request, ACR, message at a Charging Data Function, CDF, node as said charging node; and receiving a Credit Control Request, CCR, at an Online Charging System, OCS, as said charging node.

25. The method of claim 21, further comprising, in response to receiving the charging message, identifying any additional IMS call sessions supported by the first and second IMS nodes, and performing at least one of:
initiating termination of each identified additional IMS call session; and
adapting charging information associated with each additional IMS call session, as a function of the detection time.

26. A charging node comprising:
one or more communication interfaces configured to receive a charging message from a first IP Multimedia Subsystem, IMS, node in an IMS network, where the first IMS node is supporting an IMS call session and the charging message indicates a communication failure at a second IMS node supporting the IMS call session and a detection time for the communication failure; and
a processing circuit operatively associated with the one or more communication interfaces and configured to:
identify charging information associated with the IMS call session; and
adapt the charging information as a function of the detection time.

27. The charging node of claim 26, wherein the processing circuit is configured to initiate termination of the IMS call session responsive to receiving the charging message.

28. The charging node of claim 26, wherein the processing circuit is configured to adapt the charging information as a function of the detection time by performing at least one of: adapting charges for at least a portion of the IMS call session; and indicating the communication failure in a charging record generated for the IMS call session, for use by a downstream billing system in adapting charges assessed for the IMS call session.

29. The charging node of claim 26, wherein the charging node comprises a Charging Data Function, CDF node and the charging messages comprises an ACcounting Request, ACR, message.

30. The charging node of claim 26, wherein the charging node comprises a Online Charging System, OCS, and wherein the charging message comprises a Credit Control Request, CCR.

31. The charging node of claim 26, wherein the processing circuit is configured to, in response to the charging message, identify any additional IMS call sessions being supported by the first and second IMS nodes, and perform at least one of:
initiate termination of each identified additional IMS call session; and
adapt charging information associated with each additional IMS call session, as a function of the detection time.
